(19) United States
(12) Patent Application Publication
(10) Pub. No.: US 2026/0358212 A1
(43) Pub. Date: Nov. 12, 2026

(54) JIG FOR FATIGUE TESTING FOR PRIMARY BARRIER PLATE FOR LIQUEFIED GAS STORAGE SYSTEM AND FATIGUE TESTING METHOD USING THE SAME

(71) Applicant: Pusan National University Industry-University Cooperation Foundation, Busan (KR)

(72) Inventors: Jaemyung LEE, Busan (KR); Gyounghun LEE, Busan (KR)

(21) Appl. No.: 19/664,910

(22) Filed: Apr. 30, 2026

(30) Foreign Application Priority Data
May 9, 2025 (KR) 10-2025-0060430

(51) Int. Cl. G01N 3/08; F17C 13/02; G01N 3/20

(52) U.S. Cl. CPC G01N 3/08; F17C 13/02; G01N 3/20; G01N 2203/0073

(57) ABSTRACT

A fatigue-test jig for a primary-barrier plate structure used in a liquefied-gas storage system includes: when the four quadrants defined by the cross (+)-shaped wrinkle of the plate test specimen are designated as quadrants 1 through 4 in counter-clockwise order starting from the upper-right, a first to fourth upper fixing plate each attached to the corresponding quadrant of the upper surface of the plate structure; a first to fourth lower fixing plate each attached to the respective upper fixing plate by a fastening member that penetrates the plate test specimen from its lower surface; a first coupler and a second coupler, each coupled to one end of either the first or second lower fixing plate and either the third or fourth lower fixing plate, respectively, and configured to receive repetitive fatigue loads in the Y-axis direction from the fatigue-testing apparatus; and an initial-pre-strain module installed between the first and second lower fixing plates and between the third and fourth lower fixing plates, the module applying force in the X-axis direction to the first and second lower fixing plates and to the third and fourth lower fixing plates to impose an initial pre-strain.

### CROSS-REFERENCE TO RELATED APPLICATION

The present application claims priority under 35 U.S.C. § 119(a) to Korean Patent Application No. 10-2025-0060430 filed in the Korean Intellectual Property Office on May 9, 2025, which is incorporated herein by reference in its entirety.

### TECHNICAL FIELD

The present disclosure relates to a jig for securing a plate structure to a fatigue testing apparatus, and more specifically to a jig for fixing a plate structure to a fatigue testing apparatus for the fatigue testing of plate structures formed as a main body, such as the membrane that constitutes the insulated cargo hold of an LNG carrier.

### BACKGROUND TECHNOLOGY

LNG carriers must be equipped with cargo holds that can store and retain LNG liquefied at cryogenic temperatures, and these cargo holds are manufactured under very stringent conditions. This is because LNG has a vapor pressure higher than atmospheric pressure and a temperature of approximately −162 °C.

Therefore, to safely store and retain LNG, the cargo hold must be constructed from materials capable of withstanding ultra-low temperatures (e.g., aluminum steel, stainless steel, 35% nickel steel, etc.) and must also be designed with a unique insulation structure that resists thermal stress and thermal contraction while preventing heat ingress.

Fatigue testing is being performed on the membrane, a corrugated plate structure that forms the insulated structure of the cargo hold, to ensure the stability of the cargo hold of LNG carriers.

For plate structures such as the membrane of an insulated cargo hold, conventional fatigue tests use a jig to secure the test specimen in order to evaluate the fatigue life of the plate structure, and when the application of a pre-strain that simulates the actual service environment is required, separate loading equipment or a complex assembly of parts is needed.

However, conventional jigs have many components for securing the test specimen, which creates clearance when coupled with the equipment, and due to vibration or micro-displacement caused by cyclic loading, maintaining the exact initial condition is difficult, potentially affecting test reliability.

Furthermore, because a separate actuator or load frame is required to apply the initial deformation, the configuration of fatigue testing equipment becomes complex and test efficiency is reduced.

### DESCRIPTION OF THE INVENTION

### Problem to be Solved

The present disclosure is intended to solve the problems of the aforementioned prior art, and its purpose is to provide a fatigue-test jig for primary-barrier plate structures used in liquefied-gas storage systems, as well as a fatigue-testing method employing such plate structures, which can accurately apply an initial deformation (pre-strain) to the plate structure with a simple configuration, minimize component parts to reduce clearance between equipment, and thereby improve test precision and reliability.

### Means for Solving the Problem

The fatigue-test jig for the primary barrier plate structure of a liquefied-gas storage system according to the present disclosure for achieving the above-mentioned purpose, which is a jig for mounting a plate structure having a cross-shaped (+) intersecting wrinkle portion onto a fatigue-test apparatus, and wherein the four quadrants defined by the wrinkle portion of the plate-structure test specimen are defined as first through fourth quadrants in counter-clockwise order from the upper-right, may comprise: first through fourth upper fixing plates each attached to the first through fourth quadrants of the upper surface of the plate structure; first through fourth lower fixing plates each attached to the respective first through fourth upper fixing plates by a fastening member that penetrates the plate-structure test specimen from its lower surface; a first coupler and a second coupler each attached to one end of the first or second lower fixing plate, and the third or fourth lower fixing plate, respectively, and receiving repetitive fatigue loads in the Y-axis direction from the fatigue-test apparatus; and an initial-pre-strain module installed between the first and second lower fixing plates and between the third and fourth lower fixing plates, respectively, which applies force in the X-axis direction to the first and second lower fixing plates and to the third and fourth lower fixing plates to impose an initial deformation (pre-strain).

The initial deformation applying module may comprise: first, a first screw shaft and a second screw shaft having threads formed on an outer surface, each being fixed respectively to the first lower fixing plate and the fourth lower fixing plate; a first fixing member and a second fixing member for fixing the first screw shaft and the second screw shaft to the second lower fixing plate and the third lower fixing plate, respectively; a first nut member disposed between the first lower fixing plate and the second lower fixing plate, engaged with the threads of the first screw shaft so as to apply a force in the X-axis direction to the second lower fixing plate relative to the first lower fixing plate; and a second nut member disposed between the third lower fixing plate and the fourth lower fixing plate, engaged with the threads of the second screw shaft so as to apply a force in the X-axis direction to the third lower fixing plate relative to the fourth lower fixing plate.

According to one embodiment of the present disclosure, a first variant portion and a second variant portion, in which the first screw shaft is fixed to one end of the first lower fixing plate and the second lower fixing plate, may be formed so as to be bent at a right angle, and a third variant portion and a fourth variant portion, in which the second screw shaft is fixed to one end of the third lower fixing plate and the fourth lower fixing plate, may also be formed so as to be bent at a right angle.

The first screw shaft and the second screw shaft are bolts, and the first nut member and the second nut member, as well as the first fixing member and the second fixing member, may be nuts.

The X-axis direction lengths of the second lower fixing plate and the third lower fixing plate may each be formed longer than the X-axis direction lengths of the first lower fixing plate and the third lower fixing plate, respectively.

A connecting portion that couples to the first coupler and the second coupler may be integrally formed in the X-axis direction portion of the second lower fixing plate and the third lower fixing plate, extending in the Y-axis direction from the X-axis center of the plate-structure specimen.

The method for fatigue testing the plate structure using a fatigue test jig for the primary barrier plate structure of a liquefied gas storage system according to the present disclosure,
(S1) a step of coupling the first to fourth upper fixing plates and the first to fourth lower fixing plates to each of the first to fourth quadrants of the upper and lower surfaces of the plate structure test specimen;
(S2) A step of applying an initial deformation (pre-strain) by exerting force in the X-axis direction between the first lower fixing plate and the second lower fixing plate, and between the third lower fixing plate and the fourth lower fixing plate, using an initial deformation applying module;
(S3) a step of connecting the first coupler and the second coupler to a fatigue testing device; and
(S4) The fatigue testing apparatus may include a step of performing a fatigue test by repeatedly applying a fatigue load in the Y-axis direction to the first coupler and the second coupler.

The initial-deformation-applying module comprises: a first screw shaft and a second screw shaft each fixed to the first lower fixing plate and the fourth lower fixing plate, respectively; a first fixing member and a second fixing member that fix the first screw shaft and the second screw shaft to the second lower fixing plate and the third lower fixing plate, respectively; a first nut member engaged with the first screw shaft between the first lower fixing plate and the second lower fixing plate that applies a force in the X-axis direction to the second lower fixing plate relative to the first lower fixing plate; and a second nut member engaged with the second screw shaft between the third lower fixing plate and the fourth lower fixing plate that applies a force in the X-axis direction to the third lower fixing plate relative to the fourth lower fixing plate; and in step (S2), by rotating the first nut member and the second nut member, a linear displacement of a predetermined distance along the axial direction of the first and second screw shafts is simultaneously effected, thereby applying an initial deformation (pre-strain).

### Effect of the Invention

According to the present disclosure, an initial strain applying module that applies force in the width direction (X-axis direction) to impart an initial deformation (pre-strain) is configured between the inner width-direction ends of the first lower fixing plate and the second lower fixing plate, and between the inner width-direction ends of the third lower fixing plate and the fourth lower fixing plate, thereby forming a plate structure.

By simulating the actual environment in which it is used, fatigue testing can be performed with high precision and reliability.

In particular, the initial deformation applying module comprises a first screw shaft and a second screw shaft having a bolt or bolt-like structure, and a first nut member and a second nut member having a nut or nut-like structure that are helically engaged on the outer surfaces of the first and second screw shafts; by rotating the first and second nut members to move the first and second screw shafts axially, a force can be applied in the X-direction to the first through fourth lower fixing plates, thereby imposing an initial deformation (pre-strain) on the plate-structure test specimen.

Therefore, the components for applying initial deformation can be greatly simplified, and the process of applying initial deformation can be performed very easily and accurately.

Furthermore, because the first lower fixing plate and the second lower fixing plate, as well as the third lower fixing plate and the fourth lower fixing plate that form the initial-deformation-applying module have an asymmetric configuration and can be connected to the fatigue testing device via a first coupler and a second coupler, the module can be formed between the first and second lower fixing plates and between the third and fourth lower fixing plates while also minimizing the components required to connect the first through fourth lower fixing plates to the fatigue testing device.

### BRIEF DESCRIPTION OF THE DRAWINGS

FIG. 1 is a perspective view showing a fatigue-test jig for the primary wall-plate structure of a liquefied-gas storage system according to an embodiment of the present disclosure.

FIG. 2 is an exploded perspective view of the fatigue test jig for the plate structure shown in FIG. 1. FIG. 3 is a plan view of the fatigue test jig for the plate structure shown in FIG. 1.

FIG. 4 is a rear view of the fatigue test jig for the plate structure shown in FIG. 1, after rotating the jig 180 degrees about the Y-axis.

FIG. 5 is a drawing that shows an enlarged view of portion A of FIG. 4.

### SPECIFIC DETAILS FOR PRACTICING THE INVENTION

Referring to the attached drawings below, the fatigue-test jig for the primary barrier plate structure of a liquefied-gas storage system according to embodiments of the present disclosure, and the fatigue-testing method for the plate structure using the jig, are described in detail. The present disclosure can be subjected to various modifications and can take many forms; therefore, specific embodiments are illustrated in the drawings and described in detail in the text. However, this is not intended to limit the disclosure to a particular disclosed form, and should be understood to encompass all modifications, equivalents, or alternatives within the spirit and technical scope of the disclosure. Similar reference numerals are used for similar components when describing each drawing.

Furthermore, terms such as “first” and “second” may be used to describe various components, but the components themselves shall not be limited by those terms. These terms are used solely for the purpose of distinguishing one component from another. For example, without departing from the scope of the disclosure, a first component may be referred to as a second component, and similarly a second component may be referred to as a first component. Moreover, unless otherwise defined, all terms used herein—including technical or scientific terms—have the same meaning as would be commonly understood by a person of ordinary skill in the art to which the disclosure belongs. Terms that are commonly used and defined in dictionaries should be interpreted as having the meaning consistent with their context in the relevant technology, and unless explicitly defined in this application, they shall not be interpreted in an idealized or overly formal sense.

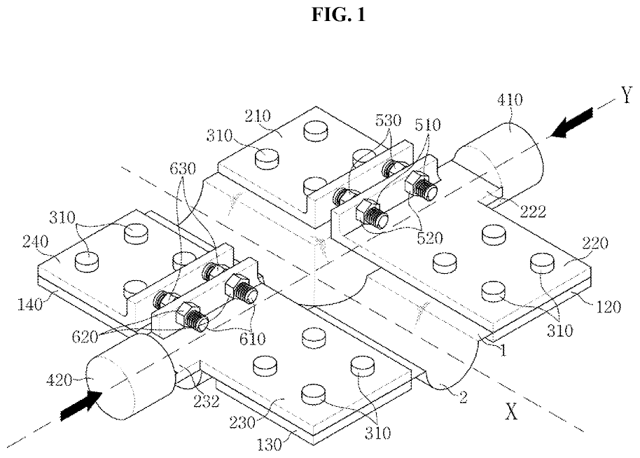

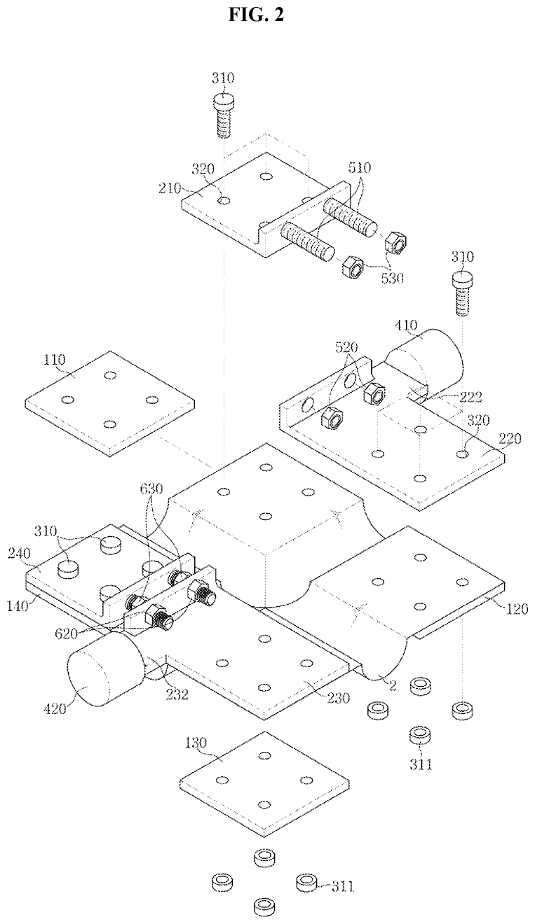

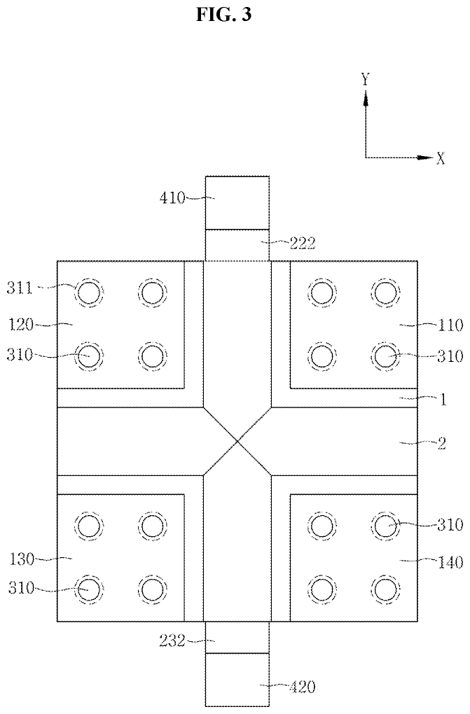

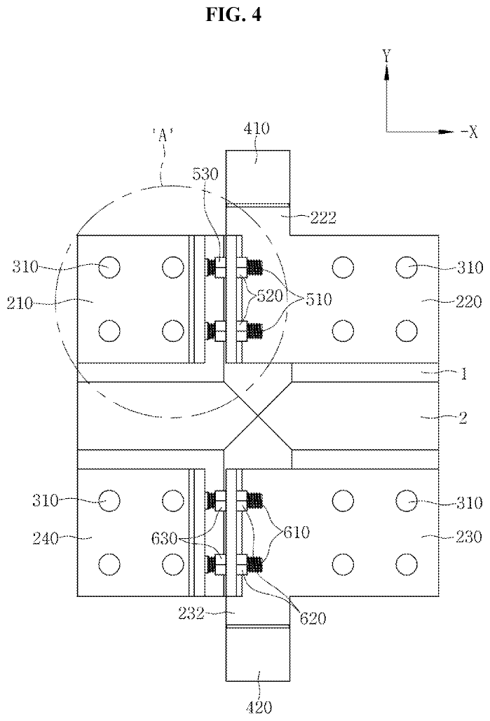

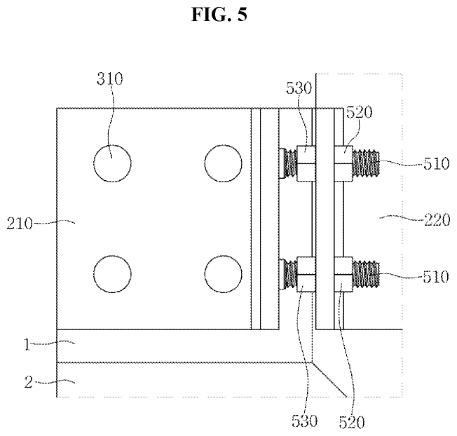

Referring to FIGS. 1 through 5, the fatigue-test jig for the primary barrier plate structure of a liquefied-gas storage system according to an embodiment of the present disclosure is configured to mount a plate-like test specimen (1) resembling a membrane, which has a cross-shaped (+) intersecting wrinkle portion (2) at its center, onto a fatigue-testing machine; it includes first through fourth upper fixing plates (110, 120, 130, 140), first through fourth lower fixing plates (210, 220, 230, 240), bolts (310) and nut.

It includes a plurality of fastening members comprising tr (311), a first coupler (410), a second coupler (420), and an initial deformation applying module.

For the purpose of facilitating understanding of the present disclosure, the upper and lower surfaces of the plate-structure test specimen (1) are defined, for convenience, as follows: the side where the wrinkle portion (2) bulges outward convexly is defined as the upper surface, and the opposite side is defined as the lower surface. Furthermore, when the plate-structure test specimen (1) is connected to a fatigue testing apparatus and subjected to fatigue loading, the direction of the applied fatigue load is defined as the longitudinal direction (Y-axis direction) of the specimen, and the direction orthogonal to it is defined as the width direction (X-axis direction). When viewing the specimen from above, the four quadrants partitioned by the wrinkle portion (2) are defined, starting from the upper-right quadrant and proceeding counter-clockwise, as quadrants 1 through 4.

The first to fourth upper fixing plates (110, 120, 130, 140) are each attached to the first to fourth quadrants of the upper surface of the plate-shaped specimen (1). The first to fourth upper fixing plates (110, 120, 130, 140) comprise rectangular plates made of high-strength metal material and are coupled to the upper surface of the plate structure specimen (1) by multiple bolts (310) and nuts (311).

The first through fourth upper fixing plates (110, 120, 130, 140) can be made of square flat plates of the same size, but depending on the size and shape of the plate structure test specimen (1), they may also be formed as rectangular flat plates with differing width and height.

The first to fourth upper fixing plates (110, 120, 130, 140) may be formed with multiple bolt fastening holes (320)—four in this embodiment—so that the fastening bolt (310) can pass through them.

The first through fourth lower fixing plates (210, 220, 230, 240) are plate-structure test specimens.

In the first to fourth quadrants of (1), each is coupled to the lower surface. The first to fourth lower fixing plates (210, 220, 230, 240) are each attached to the first to fourth upper fixing plates (110, 120, 130, 140) by bolts (310) and nuts (311) that penetrate the plate-structure test specimen (1). That is, the first lower fixing plate (210) is coupled to the first upper fixing plate (110) by a bolt (310) and nut (311) on the lower surface of the first quadrant of the plate-structure test specimen (1); the second lower fixing plate (220) is coupled to the second upper fixing plate (120) by a bolt (310) and nut (311) on the lower surface of the second quadrant of the plate-structure test specimen (1). Moreover, the third lower fixing plate (230) is coupled to the third upper fixing plate (130) by a bolt (310) and nut (311) on the lower surface of the third quadrant of the plate-structure test specimen (1), and the fourth lower fixing plate (240) is coupled to the fourth upper fixing plate (140) by a bolt (310) and nut (311) on the lower surface of the second quadrant of the plate-structure test specimen (1).

The second lower fixing plate (220) and the third lower fixing plate (230) are connected to the fatigue testing device via the first coupler (410) and the second coupler (420), receiving repetitive fatigue loads in the Y-axis direction. The second lower fixing plate (220) and the third lower fixing plate (230) are formed as flat plates larger than the first lower fixing plate (210) and the fourth lower fixing plate (240), and are coupled to the plate-structure test specimen (1) in an asymmetric configuration. In other words, the X-axis lengths of the second lower fixing plate (220) and the third lower fixing plate (230) are respectively . . .

It consists of a rectangular flat plate whose length in the X-axis direction exceeds that of the lower fixing plate (240). Accordingly, the single ends (inner portions in the width direction) of the first lower fixing plate (210) and the second lower fixing plate (220) that face each other, as well as the single ends (inner portions in the width direction) of the third lower fixing plate (230) and the fourth lower fixing plate (240) that face each other, are positioned at a location spaced a predetermined distance from the widthwise center of the plate-structure test specimen (1).

At the inner side portions in the width direction of the second lower fixing plate (220) and the third lower fixing plate (230), a connecting portion (222, 232) that extends in the Y-axis direction from the central portion in the width (X-axis) direction of the plate-structure test specimen (1) and is coupled to the first coupler (410) and the second coupler (420) may be formed integrally.

The first coupler (410) and the second coupler (420) are for connecting the second lower fixing plate (220) and the third lower fixing plate (230) to the fatigue testing device, and are formed as a cylindrical or polygonal column that can be secured to the connection portions (222, 232) of the second lower fixing plate (220) and the third lower fixing plate (230) by fastening means such as welding or bolts.

Between the opposing single ends (inner widthwise ends) of the first lower fixing plate (210) and the second lower fixing plate (220), and between the opposing single ends (inner widthwise ends) of the third lower fixing plate (230) and the fourth lower fixing plate (240), a plate-structure test specimen is positioned prior to fatigue testing.

An initial-deformation (pre-strain) applying module, which applies a force that pushes apart in the width (X-axis) direction, is installed at (1).

The initial transformation module comprises a first screw shaft (510) and a second screw shaft (610) each fixed to the first lower fixing plate (210) and the fourth lower fixing plate (240), respectively, and a first fixing member (520) and a second fixing member (620) each securing the first screw shaft (510) and the second screw shaft (610) to the second lower fixing plate (220) and the third lower fixing plate (230), respectively, the first lower fixing plate (210) and the second lower fixing plate.

The assembly may include a first nut member (530) attached to the first screw shaft (510) that applies a force in the X-axis direction to the second lower fixing plate (220) relative to the first lower fixing plate (210), and a second nut member (630) attached to the second screw shaft (610) between the third lower fixing plate (230) and the fourth lower fixing plate (240) that applies a force in the X-axis direction to the third lower fixing plate (230) relative to the fourth lower fixing plate (240).

The first screw shaft (510) and the second screw shaft (610) can be configured by applying a bolt such as a machine bolt, and the first fastening member (520) and the second fastening member (620) together with the first nut member (530) and the second nut member (630) can be configured by applying nuts having threads formed on the inner surface.

To facilitate the installation of the first screw shaft (510) and the second screw shaft (610), the first fixing member (520) and the second fixing member (620), and the first nut member (530) and the second nut member (630), and to reliably and easily apply an initial deformation (pre-strain) in the X-axis direction, the inner edges in the width direction of the first lower fixing plate (210) and the second lower fixing plate (220), as well as the inner edges in the width direction of the third lower fixing plate (230) and the fourth lower fixing plate (240), may be formed so as to be bent at a right angle.

The first end of the first screw shaft (510) and the second screw shaft (610) may be welded to and fixed to the bent portion of the inner side of the widthwise direction of the first lower fixing plate (210) and the fourth lower fixing plate (240). In addition, the other ends of the first screw shaft (510) and the second screw shaft (610) are installed so as to pass through the bent portion of the inner side of the widthwise direction of the second lower fixing plate (220) and the third lower fixing plate (230), and are fixed to the bent portion of the inner side of the widthwise direction of the second lower fixing plate (220) and the third lower fixing plate (230) by the first fixing member (520) and the second fixing member (620).

the first fixing member (520) and the second fixing member (620), and the first nut member (530) and the second nut member (630) are helically coupled to the first screw shaft (510) and the second screw shaft (610) at both sides of the bent portion of the inner ends in the width direction of the second lower fixing plate (220) and the third lower fixing plate (230).

Accordingly, when the first nut member (530) and the second nut member (630) are rotated using a tool, each nut member moves along the axial direction of the first screw shaft (510) and the second screw shaft (610), thereby applying an external force in the X-axis direction to the second lower fixing plate (220) and the third lower fixing plate (230), which allows an initial deformation (pre-strain) to be imposed on the plate-structure test specimen (1) in a direction orthogonal to the fatigue load.

The method of performing a fatigue test on a plate structure using a fatigue test jig configured as described is explained as follows.

First, the first to fourth upper fixing plates (110, 120, 130, 140) and the first to fourth lower fixing plates (210, 220, 230, 240) are mounted on each of the first to fourth quadrants of the upper and lower surfaces of the plate structure test specimen (1), and a fastening member comprising a bolt (310) and a nut (311) securely couples the first to fourth upper fixing plates (110, 120, 130, 140), the plate structure test specimen (1), and the first to fourth lower fixing plates (210, 220, 230, 240) together into an integrated unit.

Next, the first nut member (530) and the second nut member (630) of the initial deformation module are rotated by a certain amount, moving the first screw shaft (510) and the second screw shaft (610) toward the right in the drawing. Accordingly, the second lower fixing plate (220) and the third lower fixing plate (230) each experience a force pushing them to the right relative to the first lower fixing plate (210) and the fourth lower fixing plate (240), and a pre-strain is applied to the plate structure specimen (1) in the X-axis direction.

Thus, when an initial deformation (pre-strain) is applied in the X-axis direction to the plate-structure test specimen (1), the first coupler (410) and second coupler (420) connected to the second lower fixing plate (220) and third lower fixing plate (230) are connected to the fatigue testing apparatus and mounted.

The fatigue testing device performs a fatigue test by repeatedly applying a fatigue load in the Y-axis direction to the plate structure specimen (1) through the first coupler (410) and the second coupler (420).

The fatigue test jig according to the present disclosure includes an initial pre-strain applying module that applies force in the X-axis direction between the inner edges in the width direction of the first lower fixing plate (210) and the second lower fixing plate (220), as well as between the inner edges in the width direction of the third lower fixing plate (230) and the fourth lower fixing plate (240), thereby enabling fatigue testing of plate structures in their actual service environment with high precision and reliability.

In particular, the initial-deformation-applying module comprises a first screw shaft (510) and a second screw shaft (610) having a bolt or bolt-like structure, and a first nut member (530) and a second nut member (630) having a nut or nut-like structure that is helically engaged on the outer surfaces of the first and second screw shafts; by rotating the first and second nut members (530, 630), the first and second screw shafts (510, 610) are moved axially, thereby applying a force in the X-axis direction to the first through fourth lower fixing plates (210, 220, 230, 240) and imposing an initial deformation (pre-strain) on the plate-structure test specimen (1).

Therefore, the components for applying initial deformation can be greatly simplified, and the process of applying initial deformation can be performed very easily and accurately.

Furthermore, since the first lower fixing plate (210) and the second lower fixing plate (220), as well as the third lower fixing plate (230) and the fourth lower fixing plate (240) that form the initial deformation application module have an asymmetric configuration and can be connected to the fatigue testing device via the first coupler (410) and the second coupler (420), the first lower fixing plate (210) and the second lower fixing plate.

It also has the advantage of being able to minimize the components required to connect the first through fourth lower fixing plates (210, 220, 230, 240) to a fatigue testing device, even while forming an initial-deformation g-module between (220) and between the third lower fixing plate (230) and the fourth lower fixing plate (240).

If the first lower fixing plate (210) and the second lower fixing plate (220), as well as the third lower fixing plate (230) and the fourth lower fixing plate (240), are arranged in a symmetric configuration, an initial deformation applying module must be provided at the central widthwise region of the plate-structure specimen (1). In this case, because all of the first and second lower fixing plates (210, 220) and the third and fourth lower fixing plates (230, 240) must be connected to the fatigue testing apparatus, the structure can become more complex, which is a disadvantage.

However, as described in the foregoing embodiment, by arranging the first lower fixing plate (210) and the second lower fixing plate (220), and the third lower fixing plate (230) and the fourth lower fixing plate (240) in mutually asymmetric configurations, and by fixing the first coupler (410) and the second coupler (420) to the Y-axis end portions of the second lower fixing plate (220) and the third lower fixing plate (230) for connection to a fatigue testing device, the components can be simplified.

The foregoing described a preferred embodiment of the present disclosure, but the present disclosure may be practiced with various modifications, changes, and equivalents. It is evident that the present disclosure can be equally applied by suitably modifying the above embodiment. Accordingly, the foregoing description should not be construed to limit the scope of the present disclosure as defined by the following claims.

What is claimed is:

1. A fatigue test jig for a primary barrier plate structure of a liquefied gas storage system, the fatigue test jig being configured to mount a plate-structure test specimen having a wrinkle portion intersecting in a cross shape to a fatigue test apparatus, the fatigue test jig comprising:
first through fourth upper fixing plates respectively configured to be coupled to first through fourth quadrants of an upper surface of the plate-structure test specimen, wherein the first through fourth quadrants are defined with respect to the wrinkle portion of the plate-structure test specimen and are arranged in a counterclockwise direction starting from an upper-right quadrant;
first through fourth lower fixing plates disposed at a lower surface of the plate-structure test specimen and respectively coupled to the first through fourth upper fixing plates by fastening members extending through the plate-structure test specimen;
a first coupler coupled to an end portion of at least one of the first lower fixing plate and the second lower fixing plate, and a second coupler coupled to an end portion of at least one of the third lower fixing plate and the fourth lower fixing plate, the first coupler and the second coupler being configured to receive repeated fatigue loads in a Y-axis direction from the fatigue test apparatus; and
an initial-deformation-applying module disposed between the first lower fixing plate and the second lower fixing plate and between the third lower fixing plate and the fourth lower fixing plate, the initial-deformation-applying module being configured to apply an X-axis-direction force between the first lower fixing plate and the second lower fixing plate and between the third lower fixing plate and the fourth lower fixing plate to thereby impart a pre-strain to the plate-structure test specimen.

2. The fatigue test jig of claim 1, wherein the initial-deformation-applying module comprises:
a first screw shaft having a first end fixed to the first lower fixing plate, and a second screw shaft having a first end fixed to the fourth lower fixing plate, the first screw shaft and the second screw shaft each having an externally threaded surface;
a first fixing member fixing the first screw shaft to the second lower fixing plate, and a second fixing member fixing the second screw shaft to the third lower fixing plate;
a first nut member threadedly engaged with the first screw shaft between the first lower fixing plate and the second lower fixing plate, the first nut member being configured to apply an X-axis-direction force to the second lower fixing plate relative to the first lower fixing plate; and
a second nut member threadedly engaged with the second screw shaft between the third lower fixing plate and the fourth lower fixing plate, the second nut member being configured to apply an X-axis-direction force to the third lower fixing plate relative to the fourth lower fixing plate.

3. The fatigue test jig of claim 2, wherein the first lower fixing plate and the second lower fixing plate respectively include a first deformation-applying portion and a second deformation-applying portion, each bent at a right angle and configured to fix the first screw shaft, and
the third lower fixing plate and the fourth lower fixing plate respectively include a third deformation-applying portion and a fourth deformation-applying portion, each bent at a right angle and configured to fix the second screw shaft.

4. The fatigue test jig of claim 2, wherein the first screw shaft and the second screw shaft are bolts, and the first nut member, the second nut member, the first fixing member, and the second fixing member are nuts.

5. The fatigue test jig of claim 1, wherein an X-axis-direction length of the second lower fixing plate is greater than an X-axis-direction length of the first lower fixing plate, and an X-axis-direction length of the third lower fixing plate is greater than an X-axis-direction length of the fourth lower fixing plate.

6. The fatigue test jig of claim 5, wherein the second lower fixing plate and the third lower fixing plate each include an integrally formed connection portion at an X-axis-direction end thereof, the connection portions extending in a Y-axis direction from an X-axis center of the plate-structure test specimen and being coupled to the first coupler and the second coupler, respectively.

7. A method of fatigue testing a plate structure using the fatigue test jig of claim 1, the method comprising:
coupling the first through fourth upper fixing plates and the first through fourth lower fixing plates to respective first through fourth quadrants of an upper surface and a lower surface of a plate-structure test specimen;
using the initial-deformation-applying module, applying a pre-strain by applying an X-axis-direction force between the first lower fixing plate and the second lower fixing plate and between the third lower fixing plate and the fourth lower fixing plate;
connecting the first coupler and the second coupler to a fatigue test apparatus; and
performing a fatigue test by repeatedly applying a fatigue load in a Y-axis direction to the first coupler and the second coupler using the fatigue test apparatus.

8. The method of claim 7, wherein the initial-deformation-applying module comprises:
a first screw shaft having a first end fixed to the first lower fixing plate, and a second screw shaft having a first end fixed to the fourth lower fixing plate;
a first fixing member fixing the first screw shaft to the second lower fixing plate, and a second fixing member fixing the second screw shaft to the third lower fixing plate;
a first nut member engaged with the first screw shaft between the first lower fixing plate and the second lower fixing plate, the first nut member being configured to apply an X-axis-direction force to the second lower fixing plate relative to the first lower fixing plate; and
a second nut member engaged with the second screw shaft between the third lower fixing plate and the fourth lower fixing plate, the second nut member being configured to apply an X-axis-direction force to the third lower fixing plate relative to the fourth lower fixing plate,
wherein applying the pre-strain comprises rotating the first nut member and the second nut member to cause relative linear displacement by a predetermined distance along axial directions of the first screw shaft and the second screw shaft.
